(19) United States
(12) Patent Application Publication
(10) Pub. No.: US 2004/0230671 A1
(43) Pub. Date: Nov. 18, 2004

(54) Modular access point for wireless networking

(76) Inventors: Douglas L. Rollins, Nampa, ID (US); Steven W. Price, Emmett, ID (US)

Correspondence Address: Edward J. Grundler, PARK, VAUGHAN & FLEMING LLP, Suite 201, 508 Second Street, Davis, CA, 95616, US

(21) Appl. No.: 10/871,844

(22) Filed: Jun. 17, 2004

Related U.S. Application Data
(63) Continuation of application No. 09/632,194, filed on Aug. 2, 2000, now abandoned.

(51) Int. Cl. G06F 15/177; H04B 7/00; G06F 15/16

(52) U.S. Cl. 709/220; 370/310; 709/249

(57) ABSTRACT

One embodiment of the present invention provides a computer system that implements a modular access point for clients on a wireless network. This modular access point provides the usual bridging functions to a wired network, such as an Ethernet or a Token Ring. In addition, the modular access point provides other services, such as a printer service, a facsimile service, or a firewall for connecting to a broadband connection. By providing these services within a modular access point, the present invention can reduce cost and can facilitate easier administration at the wireless network.

### BACKGROUND

1. Field of the Invention

The present invention relates to access points for wireless networks. More specifically, the present invention relates to a method and an apparatus for performing services within a modular access point that are normally performed on another network node.

2. Related Art

Current computer technology gives the mobile computer user many tools for performing business on the road. These tools include laptop computers and personal organizers. It is often necessary to interface these portable devices to a network in order to communicate with other computing devices and to provide printing and facsimile services. A number of mechanisms have been developed to facilitate this communication, including wireless networking.

Wireless networking is typically implemented with Radio Frequency (RF) or Infrared (IR) technology so that no physical connection is required with the wired network. In order to access a wireless network, the portable device typically includes an RF or IR transmitter/receiver which communicates with a corresponding transmitter/receiver that is coupled to the wired network. This transmitter/receiver on the wired network is normally contained in an “access point” that performs a conversion from a wireless network protocol to a wired network protocol.

Current access point technology, whether implemented through dedicated hardware or through software emulation, only performs a bridging function between the wireless network and the wired network. Any peripheral services, such as printing and facsimile transmission, are performed by either dedicated servers on the wired network, or alternatively by clients on the wired network which are configured to provide the peripheral services.

Providing dedicated servers on the wired network to perform peripheral services is a very costly solution because of duplicated equipment, additional wiring, and additional administration requirements. On the other hand, using clients on the wired network to provide these services places additional load on the clients which can cause the clients to have performance problems.

What is needed is a modular access point that provides peripheral services in addition to the normal bridging functions of an access point, thereby reducing cost and facilitating easier administration of the wireless network.

### SUMMARY

One embodiment of the present invention provides a computer system that implements a modular access point for clients on a wireless network. The modular access point provides the usual bridging functions to a wired network and additionally provides other services to a wireless client. These additional services can include, but are not limited to: a printer service, a facsimile service, and a firewall for connecting to a broadband service such as the Internet.

In one embodiment of the present invention, the modular access point provides wireless links to wireless clients in accordance with Institute of Electrical and Electronic Engineers (IEEE) connection protocol 802.11.

In one embodiment of the present invention, the modular access point provides a wired link to wired clients in accordance with an established protocol such as Ethernet or Token Ring.

In one embodiment of the present invention, the modular access point provides a broadband connection to a network, which may be an Intranet or the Internet.

In one embodiment of the present invention, the modular access point has an operating system that provides standard operating system services such as a printer service and a facsimile service.

In one embodiment of the present invention, the modular access point includes an access point controller which controls functions performed by the modular access point.

In one embodiment of the present invention, the modular access point provides a bridging service to connect the wireless client to the wired network.

In one embodiment of the present invention, the modular access point provides a firewall between the wireless client and the broadband network.

### BRIEF DESCRIPTION OF THE FIGURES

FIG. 1 illustrates a modular access point coupling various networks and services together in accordance with an embodiment of the present invention.

FIG. 2 is a first portion of a flowchart illustrating the process of routing a Transmission Control Protocol/Internet Protocol (TCP/IP) packet through the system in accordance with an embodiment of the present invention.

FIG. 3 is a second portion of the flowchart illustrating the process of routing a TCP/IP packet through the system in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computer Systems

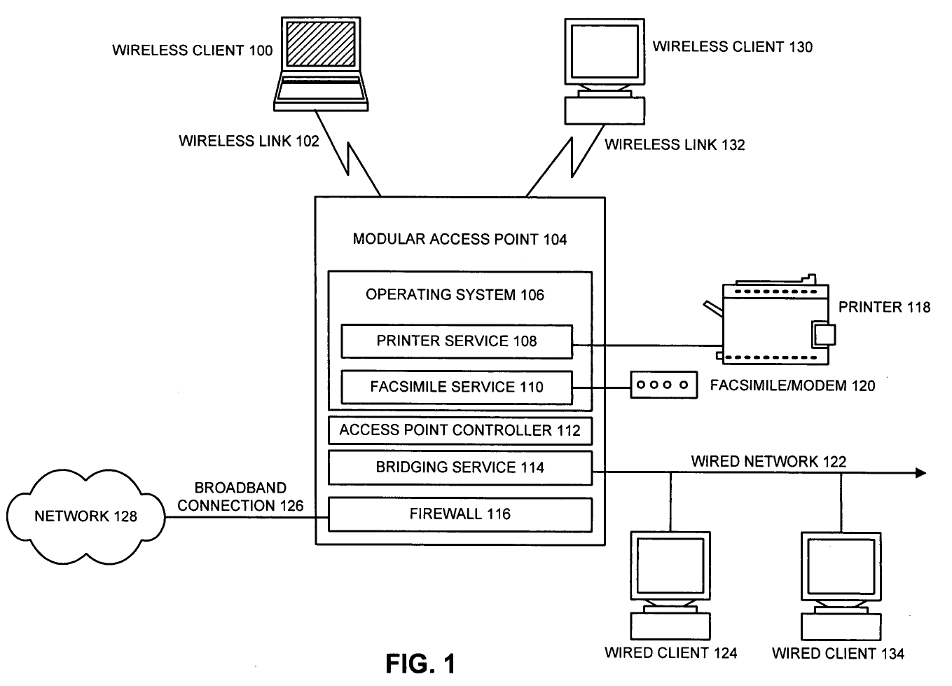

FIG. 1 illustrates modular access point 104 that communicates with wireless client 100 and wireless client 130 across wireless link 102 and wireless link 132, respectively. Also illustrated are wired client 124 and wired client 134 that communicate with modular access point 104 across wired network 122. Network 128 is coupled with modular access point 104 through broadband connection 126. Modular access point 104 is also coupled to printer 118 and facsimile/modem 120.

Modular access point 104, wireless client 100, wireless client 130, wired client 124, and wired client 134 may include any type of computer system, including, but not limited to, a computer system based on a microprocessor, a mainframe computer, a digital signal processor, a personal organizer, a device controller, and a computational engine within an appliance.

Wireless client 100, wireless client 130, wired client 124, and wired client 134 can include any node on a network including computational capability and including a mechanism for communicating across the network.

Wired network 122 can include any type of wired communication channel capable of coupling together computing nodes. This includes, but is not limited to, a local area network, a wide area network, or a combination of networks. In one embodiment of the present invention, wired network 122 includes an Ethernet.

Broadband connection 126 can include any type of broadband access mechanism for communicating with network 128. This includes, but is not limited to a T1, a T3, or a Frame Relay access mechanism.

Network 128 can include any type of wire or wireless communication channel capable of coupling together computing nodes. This includes, but is not limited to, a local area network, a wide area network, or a combination of networks. In one embodiment of the present invention, network 128 includes the Internet.

Modular access point 104 contains an operating system 106 appropriate for the type of computer used to implement modular access point 104. Operating system 106, in turn, contains a printer service 108 for accessing printer 118 and a facsimile service 110 for accessing facsimile/modem 120.

Access point controller 112 coordinates various operations performed by modular access point 104. These operations can include: routing network packets among wireless link 102, wireless link 132, wired network 122; providing a firewall 116 for communications across broadband connection 128; and controlling printer service 108 and facsimile service 110 within operating system 106. Access point controller 112 uses bridging service 114 to perform protocol conversions. In one embodiment of the present invention, access point controller 112 is implemented as a computer program on modular access point 104.

Bridging service 114 provides protocol translation between the various client connections. These client connections include, but are not limited to, wireless link 102, wireless link 132, wired network 122, and network 128. In one embodiment of the present invention, bridging service 114 is implemented as a computer program within modular access point 104.

Firewall 116 validates and authorizes access to network 128 across broadband connection 126. In one embodiment of the present invention, firewall 116 is implemented as a computer program on modular access point 104.

Process of Routing a TCP/IP Packet through the System

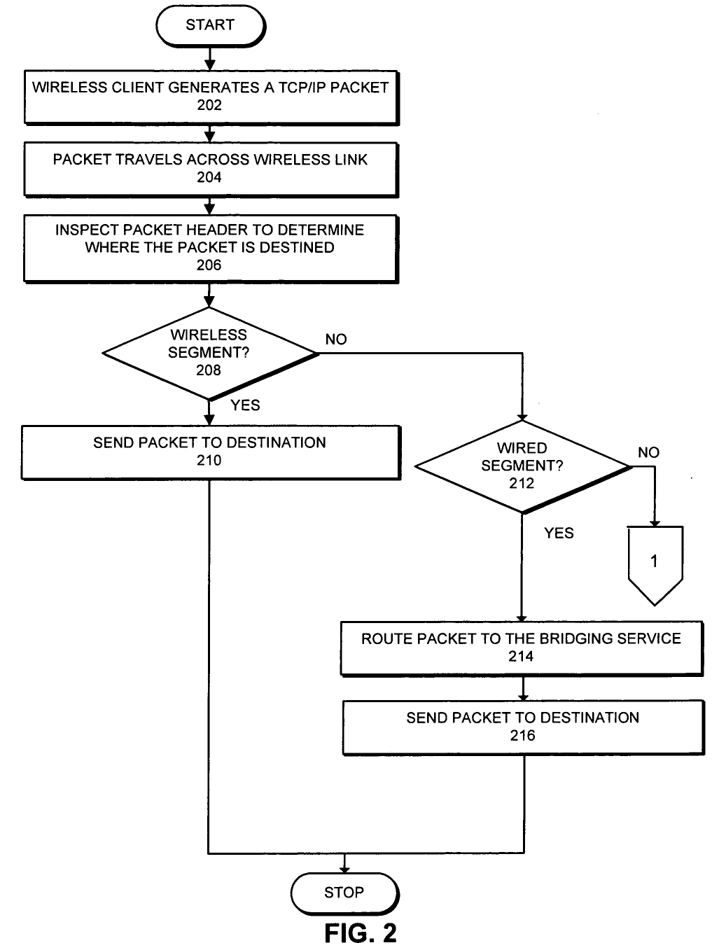

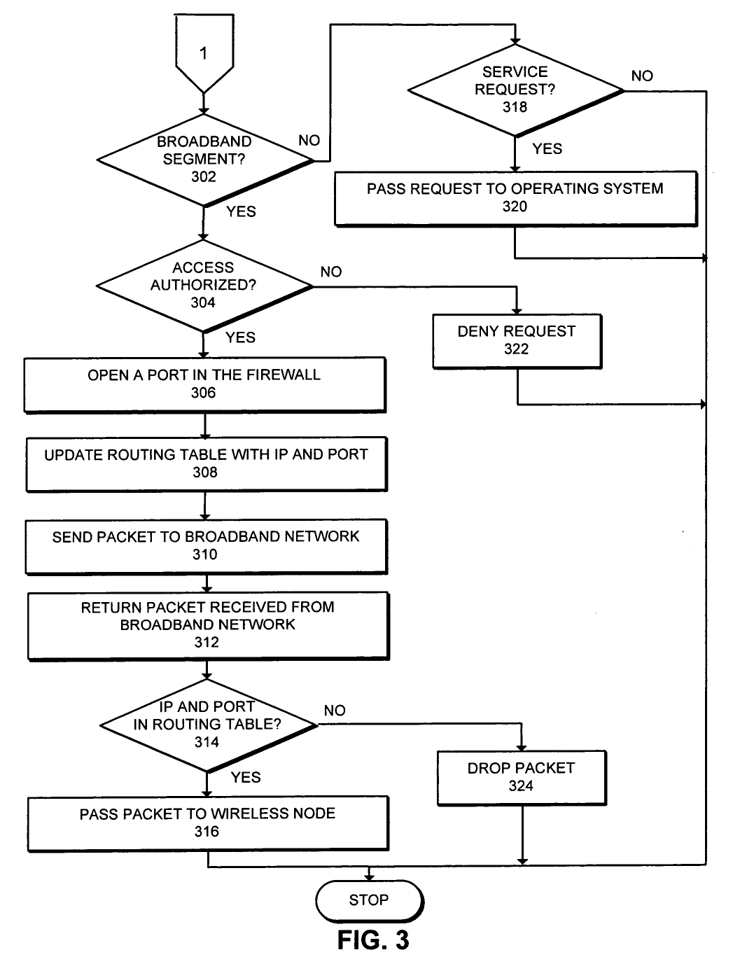

FIG. 2 and FIG. 3 provide a flow chart illustrating the process of routing a TCP/IP packet from wireless client 100 through modular access point 104 to the appropriate destination in accordance with an embodiment of the present invention. The system starts when wireless client 100 generates a TCP/IP packet requesting a service or a connection to another client (202). This packet is communicated across wireless link 102 to modular access point 104 (204).

Access point controller 112 within modular access point 104 inspects the packet header to determine the destination of the packet (206). If the packets destined for another client on the wireless segment (208), the packet is sent to the proper destination (210) across the appropriate wireless link.

If the packet is not destined for the wireless segment (208), a test is made to determine if the packet is destined for wired network 122 (212). If the packet is destined for wired client 124 or wired client 134 on wired network 122, the packet is passed to bridging service 114 (214) for possible protocol translation. Bridging service 114 performs any necessary protocol translation and then sends the packet to the destination client across wired network 122 (216).

If the packet is not destined for the wired segment (212), the system determines if the packet is being sent to the broadband segment (302). If the packet is being sent to the broadband segment, the system further determines if the client is authorized to access the broadband segment (304). If not, the request is denied (322) and the requesting client is notified with a message to contact the system administrator.

If access to the broadband segment is authorized (304), access point controller 112 opens a port in firewall 116 (306). Next, access point controller 112 updates its internal routing table with the IP address and port number of the requesting client (308). The packet is then sent through firewall 116 across broadband connection 126 to network 128 (310).

When a return packet is received from network 128 across broadband connection 126, firewall 116 routes the packet to access point controller 112 (312). Access point controller 112 examines the packet header and compares the IP address and port number with IP addresses and port numbers in its internal routing table (314). If a match is found, the packet is passed to the appropriate client on the wireless segment (316). If the IP address and port number are not found in the internal routing table of access point controller 112 (314), the packet is dropped (324) by access point controller 112.

If the packet is not destined for the broadband segment (302), the system determines if the packet includes a request for printer service 108 or facsimile service 110 (318). If the packet includes a request for printer service 108 or facsimile service 110 (318), the packet is passed to operating system 106 of modular access point 104 for the appropriate service (320). If the packet does not include a request for printer service 108 or facsimile service 10 (318), it is ignored.

The foregoing descriptions of embodiments of the invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for accessing a network service from across a wireless network, the network service being implemented by a single processor that additionally implements a modular access point for the wireless network, comprising:
receiving a packet from a wireless client on the wireless network that has access to the modular access point;
determining if the packet is destined for a client on another segment;
if the packet is destined for a client on another segment, passing the packet to the other segment;
determining if the packet is directed to a service provided by the modular access point; and
if the packet is directed to a service provided by the modular access point, performing the service.

2. The method of claim 1, wherein determining if the packet is destined for a client on another segment involves examining an Internet Protocol (IP) address and port number in a header of the packet and using the IP address and port number to determine a destination segment from one of, a Domain Name Server (DNS) table and an internal routing table.

3. The method of claim 1, wherein the service provided by the modular access point includes a printer service for printing a content of the packet.

4. The method of claim 1, wherein the service provided by the modular access point includes a facsimile service for sending a content of the packet via facsimile.

5. The method of claim 1, wherein the service provided by the modular access point includes a routing service for sending a content of the packet via a broadband network.

6. The method of claim 5, further comprising controlling access to the broadband network through a firewall.

7. The method of claim 1, wherein the wireless network conforms to Institute of Electrical and Electronic Engineers (IEEE) 802.11 protocol.

8. The method of claim 1, wherein the other segment uses one of, the Ethernet protocol and the Token Ring protocol.

9. A computer-readable storage medium storing instructions that when executed by a computer causes the computer to perform a method for accessing a network service from across a wireless network, the network service being implemented by a single processor that additionally implements a modular access point for the wireless network, the method comprising:
receiving a packet from a wireless client on the wireless network that has access to the modular access point;
determining if the packet is destined for a client on another segment;
if the packet is destined for a client on another segment, passing the packet to the other segment;
determining if the packet is directed to a service provided by the modular access point; and
if the packet is directed to a service provided by the modular access point, performing the service.

10. The computer-readable storage medium of claim 9, wherein determining if the packet is destined for a client on another segment involves examining an IP address and port number in a packet header and determining a destination segment from one of, a DNS table and an internal routing table.

11. The computer-readable storage medium of claim 9, wherein the service provided by the modular access point includes a printer service for printing a content of the packet.

12. The computer-readable storage medium of claim 9, wherein the service provided by the modular access point includes a facsimile service for sending a content of the packet via facsimile.

13. The computer-readable storage medium of claim 9, wherein the service provided by the modular access point includes a routing service for sending a content of the packet via a broadband network.

14. The computer-readable storage medium of claim 13, wherein access to the broadband network is controlled through a firewall.

15. The computer-readable storage medium of claim 9, wherein the wireless network conforms to the IEEE 802.11 protocol.

16. The computer-readable storage medium of claim 9, wherein the other segment uses one of, the Ethernet protocol and the Token Ring protocol.

17. An apparatus that facilitates accessing a network service from across a wireless network, the network service being implemented by a single processor that additionally implements a modular access point for the wireless network, comprising:
a receiving mechanism that is configured to receive a packet from a wireless client on the wireless network that has access to the modular access point;
a determining mechanism that is configured to determine if the packet is destined for a client on another segment;
a routing mechanism that is configured to route the packet to the other segment if the packet is destined for the client on another segment;
a determining mechanism that is configured to determine if the packet is directed to a service provided by the modular access point; and
a service mechanism that is configured to perform the service if the packet is directed to a service provided by the modular access point.

18. The apparatus of claim 17, wherein the determining mechanism is configured to determine if the packet is destined for a client on another segment by examining an IP address and port number in a header of the packet, and using the IP address and port number to determine a destination segment from one of, a DNS table and an internal routing table.

19. The apparatus of claim 17, wherein the service mechanism is configured to provide a printer service for printing a content of the packet by the modular access point.

20. The apparatus of claim 17, wherein the service mechanism is configured to provide a facsimile service for sending a content of the packet via facsimile by the modular access point.

21. The apparatus of claim 17, wherein the service mechanism is configured to provide a routing service for sending a content of the packet via a broadband network by the modular access point.

22. The apparatus of claim 21, wherein the service mechanism is configured to control access to the broadband network through a firewall.

23. The apparatus of claim 17, wherein the wireless network is configured to conform to the IEEE 802.11 protocol.

24. The apparatus of claim 17, wherein the other segment is configured to use one of, the Ethernet protocol and the Token Ring protocol.
